(19) United States
(12) Patent Application Publication
(10) Pub. No.: US 2008/0143121 A1
(43) Pub. Date: Jun. 19, 2008

(54) EXIT DOOR MECHANISM

(75) Inventor: Paul J. Blasen, Dubuque, IA (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: EAGLE WINDOW & DOOR, INC.

(21) Appl. No.: 11/610,815

(22) Filed: Dec. 14, 2006

(51) Int. Cl. E05B 65/10

(52) U.S. Cl. 292/92

(57) ABSTRACT

An exit door is provided including a latching mechanism retained within an extended stile portion affixed adjacent an outer edge of an exit door main body. The latch mechanism is at least partially concealed by a removable cap. The cap is thermally insulated from an outer face of the exit door.

### TECHNICAL FIELD

The present disclosure relates to a normally concealed latch mechanism assembly in an exit door, and in particular to a latch mechanism housed inside an extended stile portion of the exit door and having a removable cap that acts as a thermal break.

### BACKGROUND

An exit door commonly includes a panic exit device with a panic bar actuating pad that latches the exit door at its top and bottom ends with a pair of vertical actuating rods. The vertical actuating rods may be surface mounted to an inner face surface of the door, or alternatively, may be concealed by being placed internally within the exit door. When concealed, the concealed vertical rods are received in a recess mounting located within the exit door. Concealed vertical rods are used instead of surface vertical rods for aesthetic purposes or in applications in which the vertical rods could be damaged easily.

Concealed vertical rods are more difficult and time-consuming to install and repair than surface mounted vertical rods. During installation, a separate pair of blocks must be installed along a free lateral side of the exit door to mask the concealed vertical rod mechanism from view. The concealed vertical rods are only accessible from the top and bottom edges of the exit door. Thus the exit door must be physically detached from the door frame for servicing.

The exit door is typically constructed of wood and has an external cladding that covers only external surfaces such as an exterior face and an interior face of the exit door. The external cladding protects the wood from environmental conditions and is manufactured from vinyl, aluminum, or other suitable materials. However, since the external cladding is constructed of materials that have a high thermal conductivity as compared to wood, it creates a thermally conductive path through the exit door.

The thermally conductive path may act as a thermal bridge; that is, a region of relatively high heat-flow conductance. This conductive path compromises the heat-flow resistance of the entire exit door, and can be especially troublesome since doors are frequently problematic components of a building's thermal envelope. Additionally, the thermal bridge may also cause a layer of condensate to form on the inside face surface of the exit door in cold climates.

An example of the above described exterior cladding is illustrated in FIG. 1, as a partially sectional view of a prior art exit door 20. Exit door 20 includes an exterior cladding 22 disposed along an outside surface 24 of a main body 26 of exit door 20. Exterior cladding 22 wraps around a lateral edge 28 of exit door 20, and extends to an inside face 30, where it is received by a recess 32. Exterior cladding 22 is generally flush with inside face 30 of exit door 20.

However, as may be appreciated, because the external cladding is made from a thermally conductive material, it would be desirable to add a thermal break to the exit door assembly that may reduce the amount of heat-flow from the external cladding traveling to the inside face of the exit door. Additionally, it would be desirable to create an exit door with concealed vertical rods that can be accessed by way of its inside face.

### BRIEF DESCRIPTION OF THE DRAWINGS

Features and advantages of the extended stile portion of the exit door will become apparent to those skilled in the art from the following detailed description of embodiments thereof, when read in light of the accompanying drawings, in which:

FIG. 1 is a partially sectional plan view of a prior art door with an exterior cladding;

FIG. 2 is an elevational perspective view of the exit door assembly and an exit door frame;

FIG. 2A is an enlarged perspective view of Region 2A in FIG. 2;

FIG. 3 is a partial perspective view of an exit door having one embodiment of an extended stile portion disposed therein;

FIG. 4 is a partially sectional perspective view of FIG. 3;

FIG. 5 is a partially sectional plan view of the exit door of FIG. 3, with a portion of a vertical rod assembly;

FIG. 6 is an enlarged, exploded perspective view of a U-shaped channel member and a removable cap to be assembled with the extended stile portion of FIG. 5;

FIG. 7 is an enlarged, partially exploded perspective view of a portion of an exit door of FIG. 2;

FIG. 8 is a partially sectioned elevational perspective view of a double exit door assembly; and

FIG. 9 is an exploded perspective view of an installation kit, including a removable cap, an extended stile portion, a pair of vertical rods, a pair of latch assemblies and a pair of U-shaped channels with an exit door.

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints that will vary from one implementation to another. Moreover, it will be appreciated that such a development effort might be complex and time-consuming, but would nevertheless be a routine undertaking for those of ordinary skill in the art having the benefit of this disclosure.

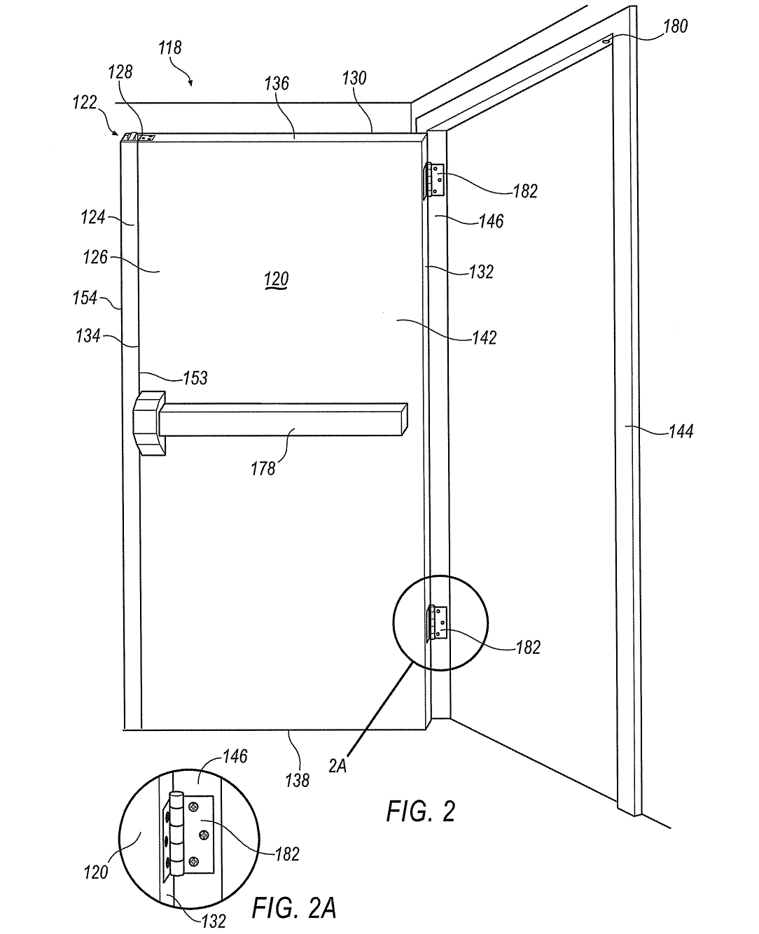

Turning now to the drawings and in particular to FIG. 2, an exemplar exit door system I 18 is illustrated including an exit door 120 and a latch mechanism 122. In the embodiment shown in FIG. 2, a removable cap 124 is coupled to an extended stile portion 128 of exit door 120 at a main body 142. An inside face 126 of main body 142 may enclose an interior volume of a building when exit door 120 is in a closed position. Main body 142 includes a pair of opposing faces, inside face 126 and an outside face 130, as well as at least one outer edge, which may include a hinged side 132, a lateral free side 134, a top edge 136 and a bottom edge 138. Main body 142 is typically constructed of wood, although other thermally non-conductive materials may be used as well.

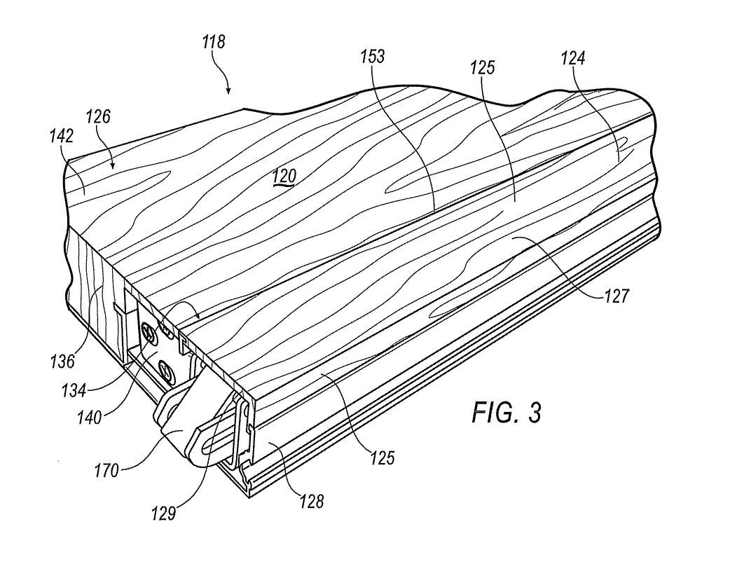

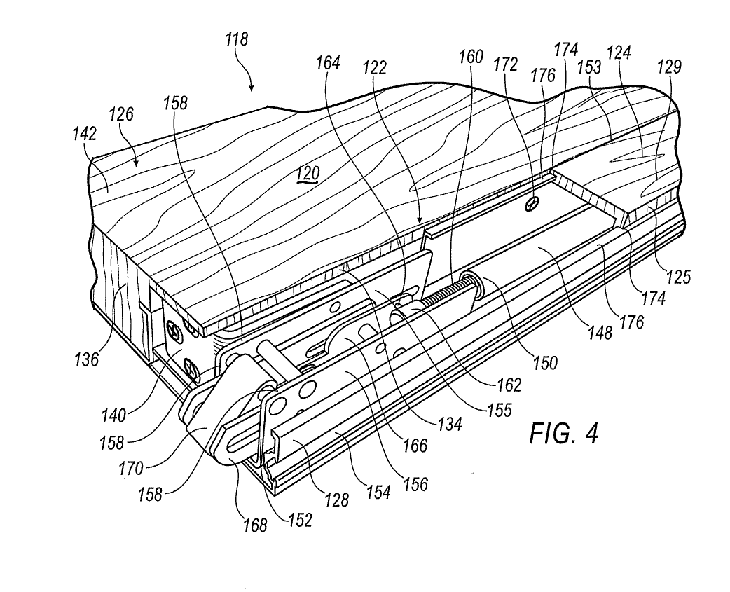

As best seen in FIGS. 3 and 4, latch mechanism 122 is generally concealed by removable cap 124 and retained within extended stile portion 128. At least a portion of removable cap 124 is interposed between inside face 126 of main body 142 and extended stile portion 128. An outer surface 125 of removable cap 124 is adjacent to inside face 126 of main body 142. At least a first portion of outer surface 125 of removable cap 124, an outside face 127, is generally flush with inside face 126. A second portion of outer surface 125 includes a top edge 129, which is generally perpendicular to outside face 127 of removable cap 124.

Extended stile portion 128 may be constructed of materials such as, but not limited to, aluminum or pultrusion fiberglass. As shown in FIG. 2, extended stile portion 128 includes an inner edge 153, which is affixed adjacent to and extends along at least a portion of lateral free side 134. A set of fasteners, such as fastener 172 which is a Phillips head screw, may also be used along the surface of lateral free side 134 to affix extended stile portion 128 to main body 142. In one embodiment, an epoxy or an adhesive may be used in place of fastener 172. Fastener 172 may be used alone or in conjunction with an additional fastening extension (not shown) to affix extended stile portion 128 to main body 142.

FIG. 4 illustrates latch mechanism 122 including a hollow rod mechanism 148. Removable cap 124 generally conceals latch mechanism 122 on inside face 126. Latch mechanism 122 is retained within a recess formed by extended stile portion 128 and removable cap 124. A latch bolt 170 is included with latch mechanism 122, and is at least partially slideable within extended stile portion 128. In particular, latch mechanism 122 may be partially retained within a U-shaped channel member 152. Latch mechanism 122 extends generally between top edge 136 and bottom edge 138 of main body 142 and is positioned adjacent to an outer side 154 within extended stile portion 128. An opposing side of exit door 120, hinged side 132, is secured to a frame edge 146 of an exit door frame 144, as discussed in more detail below.

U-shaped channel member 152 comprises an inner surface 155, an outer surface 156, and a pair of edges 158. Inner surface 155 of U-shaped channel member 152 is oriented towards an inner surface (not shown) of removable cap 124 so that edges 158 generally oppose the inner surface of removable cap 124. A fastening extension 140 is attached to U-shaped channel member 152, which is affixed to main body 142 of exit door 120 by any suitable fastening means, including, for example, Phillips head screws. Fastening extension 140 protrudes outwardly from U-shaped channel member 152 and may be affixed to at least one of top edge 136 and bottom edge 138 of main body 142. U-shaped channel member 152 may be integral with and formed as an integral portion of extended stile portion 128.

Hollow rod mechanism 148 has a threaded inner surface (not shown) and includes a first end (not shown) and a second end 150. A threaded latch rod 160, includes a first end (not shown) and a second end 162. The first end of threaded latch rod 160 is threadingly engaged with the inner surface of second end 150 of hollow rod mechanism 148. The threaded engagement allows hollow rod mechanism 148 to be operationally connected to latch bolt 170. The overall length of latch mechanism 122 may be adapted to match to the corresponding length of exit door 120 by adjusting threaded latch rod 160 inwardly or outwardly of hollow rod mechanism 148. A latch pin 164, located on second end 162 of threaded latch rod 160, is connected to a sliding portion 166 of latch mechanism 122. An end 168 of latch mechanism 122 is connected to latch bolt 170. In one embodiment U-shaped channel member 152 may also contain at least a portion of hollow rod mechanism 148.

Latch bolt 170 is actuated inwardly and outwardly from of at least one of top edge 136 or bottom edge 138 of main body 142. More specifically, latch bolt 170 selectively slides between a first locked position (as shown in FIGS. 2-4) and a second unlocked position, where latch bolt 170 protrudes away from extended stile portion 128 as latch bolt 170 moves towards the first locked position. When moving towards the second unlocked position, latch bolt 170 slidingly recedes inside said latch mechanism 122, in turn received within U-shaped channel member 152 as discussed above. As seen in FIG. 3, lateral free side 134 includes inner edge 153 of extended stile portion 128 affixed adjacent to and extending along at least a portion of lateral free side 134, and top edge 136 of main body 142 is generally perpendicular to lateral free side 134. Latch bolt 170 protrudes away from top edge 136 of main body 142 when latch bolt 170 moves towards the first locked position.

Removable cap 124 also includes a pair of slotted sides 174 that are suitable for receiving a pair of inwardly turned edges 176 of extended stile portion 128. Slotted sides 174 couple removable cap 124 to extended stile portion 128 by a slotted slide-fit engagement. The slotted slide-fit engagement retains removable cap 124 so that removable cap 124 may be removed from extended stile portion 128 by selectively sliding slotted sides 174 off of inwardly turned edges 176. A retaining pin (not shown) may also be included to prevent removable cap 124 from sliding off inwardly turned edges 176.

An actuating device, such as a panic bar actuating pad 178 is disposed adjacent to inside face 126 of main body 142, as seen in FIG. 2. A device such as actuating pad 178 is known to persons of ordinary skill in the art and may be defined as any apparatus that actuates latch mechanism 122, such as Von Duprin XP 98/99 Rim Exit Device. The first end of hollow rod mechanism is operationally connected to actuating pad 178. That is, when a compressive force is selectively manually applied to panic bar actuating pad 178 so that it moves inwardly from its unbiased normal position, hollow rod mechanism 148 is moved longitudinally towards panic bar actuating pad 178 and allows latch bolt 170 to slidingly recede inside extended stile portion 128, and in particular U-shaped channel member 152, when latch bolt 170 moves towards the second unlocked position. If latch bolt 170 is in the first locked position, as seen in FIG. 2, exit door 120 may be restricted from rotating relative to frame edge 146 if latch bolt 170 is engaged with a latch bolt recess 180 of frame edge 146. When latch bolt 170 is in the second unlocked position, it will disengage with latch bolt recess 180, and exit door 120 may be rotated relative to frame edge 146.

Hinged side 132, which is hingeable to frame 144 by means of a pair of hinges 182 as noted above. Hinges 182 allows exit door 120 to rotate relative to frame edge 146. In the embodiment shown in FIG. 2, and in particular FIG. 2A, hinge 182 is a full-mortise type hinge. However, it is understood that hinge 182 may also be a half-mortise hinge, a half-surface hinge or a full-surface hinge as well.

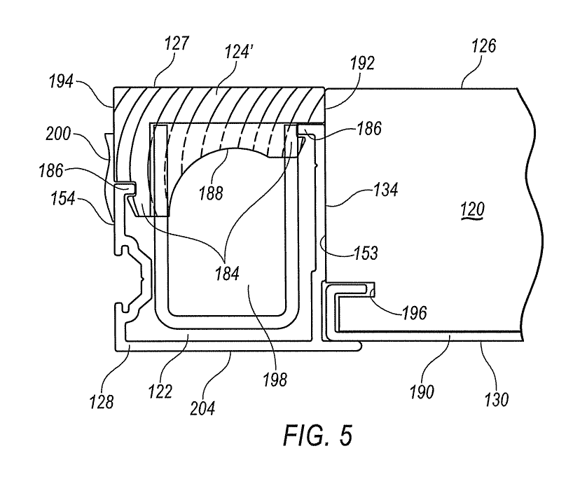

FIG. 5 illustrates a partially sectional view of a portion of latch mechanism 122 and an alternative removable cap 124′. Removable cap 124′ may be coupled to extended stile portion 128 by at least two outwardly projecting mounting tabs 184, and extended stile portion 128 may further include at least two slots 186 in selective registry with and receiving mounting tabs 184 to retain removable cap 124′ by a snap-fit engagement. In an alternative embodiment, extended stile portion 128 may include two mounting tabs 184 and removable cap 124′ may include at least two slots 186 in selective registry with and receiving mounting tabs 184. It should be noted that while FIG. 4 illustrates a slotted slide-fit engagement and FIG. 5 illustrates a snap-fit engagement, it will be appreciated that other fastening means may also be utilized to retain removable cap 124′ to extended stile portion 128, including, for example, an adhesive or an epoxy.

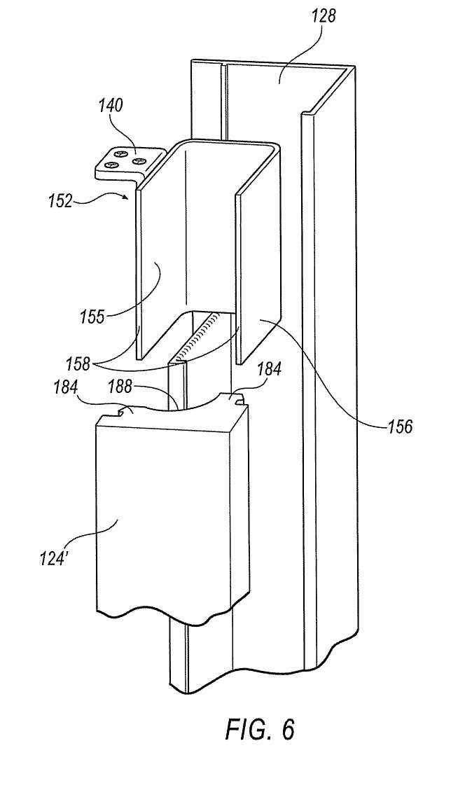

FIG. 6 is an exploded view including U-shaped channel member 152 and removable cap 124′. Inner surface 155 of U-shaped channel member 152 is oriented towards an inner surface 188 of removable cap 124′ so that edges 158 generally oppose inner surface 188, and extend parallel to mounting tabs 184. When removable cap 124′ is detached, latch mechanism 122 is exposed, providing access to hollow rod mechanism 148 and latch mechanism 122.

It should be noted that while FIGS. 2-6 illustrate latch mechanism 122, and in particular latch bolt 170, disposed at top edge 136, it will be appreciated that a latch mechanism and a latch bolt may be disposed along bottom edge 138 of main body 142. A latch mechanism may also be disposed at both top edge 136 and bottom edge 138 of main body 142 as well.

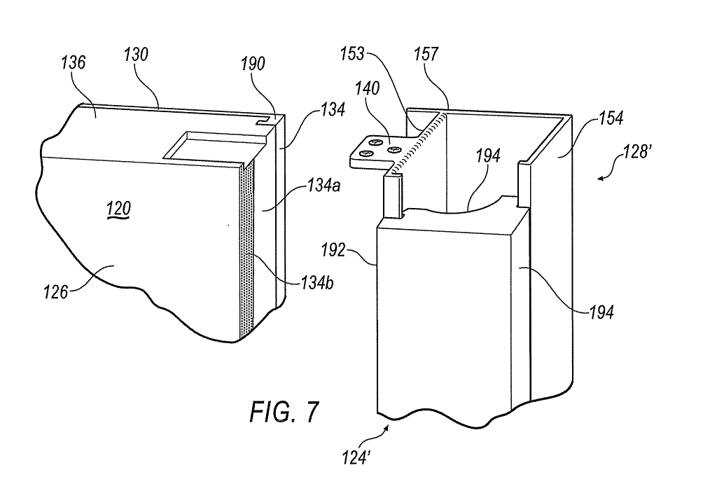

FIG. 7 is a detailed, partially exploded view of a portion of an alternative extended stile portion 128′, removable cap 124′ and main body 142. Fastening extension 140 protrudes outwardly from extended stile portion 128′ and may be affixed to at least one of top edge 136 and bottom edge 138 of main body 142. Extended stile portion 128′ includes inner edge 153, outer edge 154, a top stile edge 157 and a bottom stile edge (not shown). Lateral free side 134 includes a first edge 134A where inner edge 153 of extended stile portion 128 is affixed adjacent to and extends along at least a portion of first edge 134A. Top edge 136 of main body 142 and top stile edge 157 the bottom stile side is generally perpendicular to lateral free side 134. Top stile edge 157 is generally flush with top edge 136 and the bottom stile side is generally flush with bottom edge 138. Latch bolt 170 (not shown) protrudes away from top stile edge 157 when latch bolt 170 moves towards the first locked position.

An inner edge 192 of removable cap 124′ extends along at least a portion of lateral free side 134 of main body 142, and in particular, is disposed along the entire surface of a second edge 134B of lateral free side 134. Second edge 134B is the surface area that first edge 134A does not include. In one embodiment, as seen in FIG. 7, first edge 1 34A has a greater surface area than second edge 134B.

As best seen in FIG. 5, a cladding 190 covers outside face 130 of main body 142. Cladding 190 may be constructed of materials such as, but not limited to, aluminum or vinyl. Aluminum or vinyl is used as cladding 190 because these materials are more durable and are less prone to decay than wood. Cladding 190 also provides less maintenance than a traditional wood door, which typically needs to be painted every three to six years. However, aluminum and vinyl have a low thermal resistance when compared to the materials main body 142 is constructed of, and as a result cladding 190 creates a region of relatively high heat flow conductance. This area of high heat flow conductance may also be identified as a thermal bridge. A thermal bridge is any region of high heat flow conductance in a building envelope.

Since cladding 190 is made from a thermally conductive material, removable cap 124′ is thermally insulated from outside face 130 and at least a portion of extended stile portion 128. That is, removable cap 124′ is a thermal insulator because it is constructed of materials with a high thermal resistance. Removable cap 124′ is also a thermal insulator because it completely encases extended stile portion 128 adjacent inside face 126 while extended stile portion 128 is exposed adjacent outside face 130 of main body 142. Extended stile portion 128 may be selectively exposed to extreme environmental conditions, such as temperatures ranging between about −30° C. and about 45° C.

Removable cap 124′ is constructed of materials with a high thermal resistance and a low thermal conductivity such as, but not limited to, wood, wood veneer, polyvinyl chloride and polymethyl methacrylate. These thermally resistant materials have a higher thermal resistance and a lower thermal conductivity than the materials used to construct extended stile portion 128. In one embodiment, the thermal resistance value, known as an R-value, of removable cap 124′ is between about RSI-1.0 and RSI-10.0. Removable cap 124′ acts as a thermal break which reduces the passage of heat flow from cladding 190 to spread to inside face 126 of main body 142. A thermal break may reduce the passage of heat flow because removable cap 124′ is constructed of thermally resistant materials that reduce the flow of heat to inside face 126 of main body 142, unlike the thermally conductive materials of cladding 190.

The profile of removable cap 124′, as seen in FIG. 5, may vary depending on the particular type of extended stile portion 128 that is used. However, a preferred embodiment of removable cap 124′ may include a generally L-shaped profile. As discussed above, removable cap 124′ completely encases extended stile portion 128 at outer face 127 of removable cap 124′, and extended stile portion 128 is exposed at an outer face 202 of extended stile portion 128.

The L-shaped profile of removable cap 124′ will include inner surface 188, inner edge 192 and an outer edge 194. Inner surface 188 extends along at least a portion of inside face 126 of extended stile portion 128. Inner edge 192 of removable cap 124′ extends along at least a portion of lateral free side 134 of main body 142. Outer edge 194 extends along at least a portion of outer edge 154 of extended stile portion 128. Outer edge 194 of removable cap 124′ and outer edge 154 of extended stile portion 128 create an outermost surface 200 of exit door 120. Outermost surface 200, which comprises of both removable cap 124′ and extended stile portion 128, is spaced at a predetermined distance away from lateral free side 134.

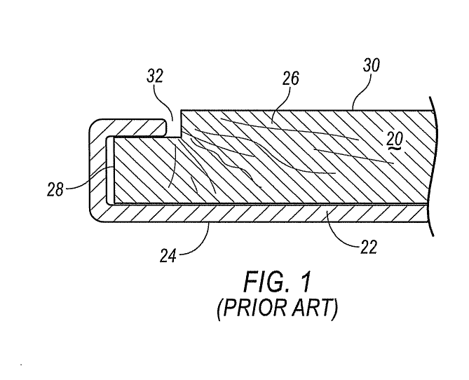

Moreover, cladding 190 only extends and is received by main body 142 at a recess 196 disposed along lateral free side 134, and not inside face 126 like the prior art as seen in FIG. 1 discussed above. Since cladding 190 does not contact inside face 126, a thermal break also exists between inner face 126 and recess 196. In the preferred embodiment, as shown in FIG. 5, recess 196 may be located at a position on lateral free side 134 of main body 142 that generally opposes extended stile portion 128. This arrangement will maximize the thermal break between cladding 190 and inside face 126, since the passage of heat flow will first pass through extended stile portion 128 before traveling to removable cap 124′.

A volume of dead space, known as void 198 exists between removable cap 124′ and U-shaped channel member 152, where hollow rod mechanism 148 and latch mechanism 122 may be located. Void 198 further acts as a thermal break between the thermally conductive materials of extended stile portion 128 and the thermally resistant materials of removable cap 124′, since air has a lower thermal conductivity than the materials extended stile portion 128 is manufactured from.

In addition to its thermally resistant properties, removable cap 124′ provides access to latch mechanism 122. This access allows repairs to latch mechanism 122 without physically detaching exit door 120 from frame 144, unlike conventional concealed rod assemblies. When removable cap 124′ is detached from extended stile portion 128, U-shaped channel member 152 is exposed. Removable cap 124′ is constructed so that after installation, removable cap 124′ may be re-useable after removal. That is, if removable cap 124′ is removed from extended stile portion 128, removable cap 124′ will not sustain severe damage and can be re-applied to extended stile portion 128.

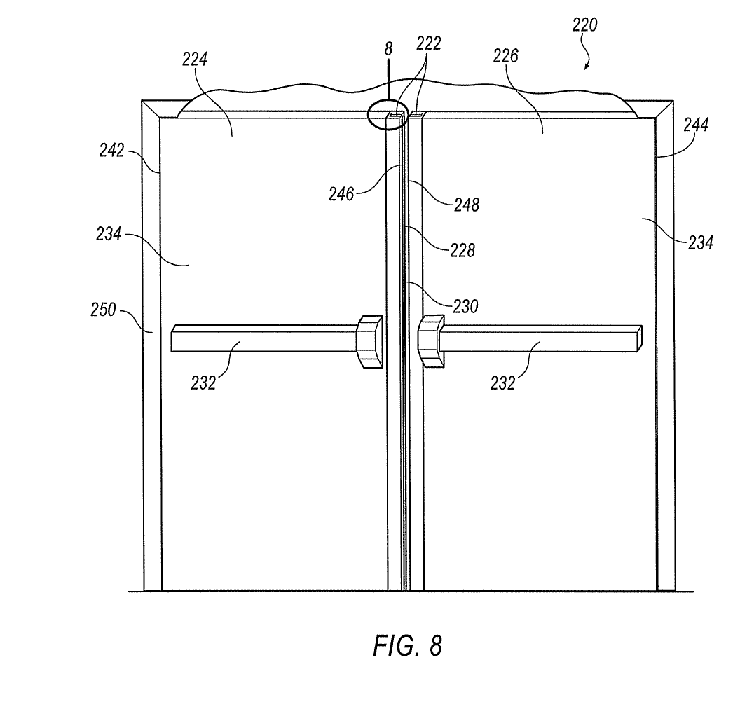

FIG. 8 illustrates another embodiment of an exit door assembly 220, similar to the embodiment shown in FIGS. 2-7, in a pair of exit doors. Latch bolt 222 is shown in the second unlocked position. At least one latch mechanism is placed inside each of a first exit door 224 and a second exit door 226. A weather strip 228 may be included to seal a gap 230 between first exit door 224 and second exit door 226. A panic bar actuating pad 232 may be placed on an inside face 234 of both first exit door 224 and second exit door 226. Alternatively, in another embodiment, panic bar actuating pad 232 may be included on only one of first exit door 224 and second exit door 226.

Exit doors 220 are oriented so that a first lateral side 242 of first exit door 224 and a first lateral side 244 of second exit door 226 are hinged (not shown), whereby a second lateral side 246 of first exit door 224 and a second lateral side 248 of second exit door 226 may be free sides rotated outwardly relative to a frame 250.

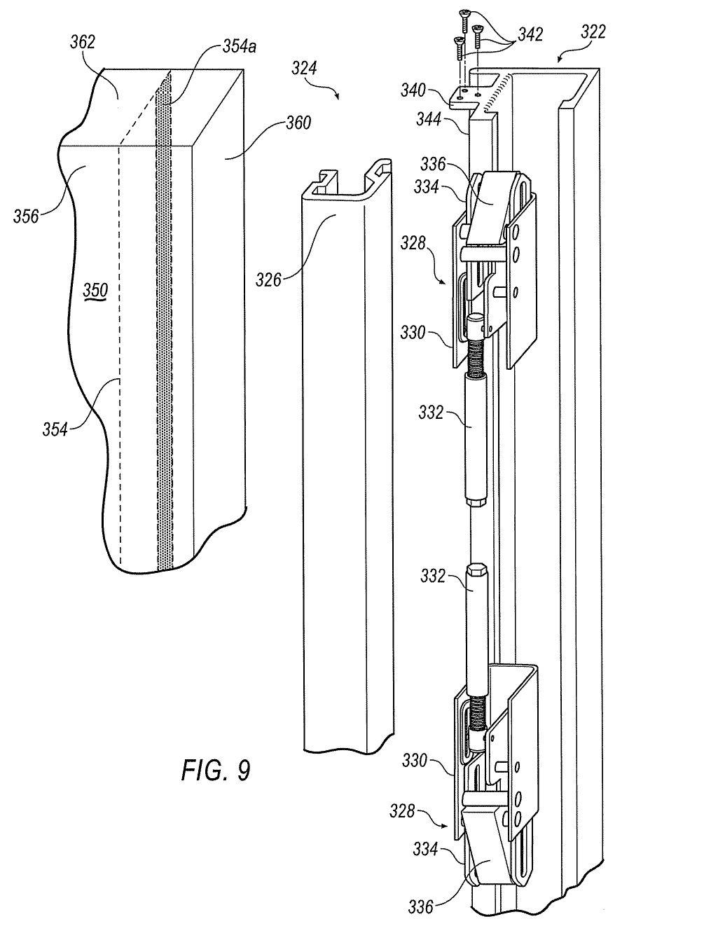

In yet another alternative embodiment, an extended stile portion 322, as shown in FIG. 9, is part of an installation kit 324 that may be applied to an exit door 350 that does not include a concealed latch mechanism. Installation kit 324 includes extended stile portion 322, a removable cap 326, and a latch mechanism 328, which includes at least one U-shaped channel member 330, at least one hollow rod mechanism 332, at least one sliding portion 334, and at least one latch bolt 336. A lateral free side 354 of a main body 356 of exit door 350 includes a first edge 354A, where an inner edge 344 of extended stile portion 322 is affixed adjacent to and extends along at least a portion of first edge 354A. At least one fastening extension 340 projects outwardly from extended stile portion 322 and is attached to main body 356 by a set of screws 342. It should be noted that while FIG. 9 illustrates screws 342 utilized to affix extended stile portion 322 to main body 356, it will be appreciated that other fasteners may also be utilized, including, for example, an adhesive or an epoxy.

Installation kit 324 may be applied to exit door 350 by first removing a lengthwise section 360 of lateral free side 354 of main body 356, so that a volume of extended stile portion 322 and a volume of removable cap 326 may replace the volume of lengthwise section 360 of main body 356 that was removed. Extended stile portion 322 may be fastened to a first portion of free lateral side 354 of main body 356. In an alternative embodiment, extended stile portion 322 may be fastened to main body 356 without removing lengthwise section 360 of free lateral side 354, if latch bolt 336 will be aligned with and selectively received by a latch bolt recess, such as latch bolt recess 180, as seen in FIG. 2. Extended stile portion 322 may be secured to at least one of a top edge 362 and a bottom edge (not shown) of main body 356 by fastening extension 340.

As seen in FIG. 9, U-shaped channel member 330 may be installed separately from extended stile portion 322 and located within a recess formed by extended stile portion 322 and removable cap 326. In another embodiment, U-shaped channel member 330 may be integral with and formed as an integral portion of extended stile portion 322. Removable cap 326 is coupled to extended stile portion 322 by fastening means such as, but not limited to, a snap-fit engagement, a slotted slide-fit engagement, an epoxy and an adhesive.

Unlike prior art latch mechanisms, installation kit 324 does not require a special routing to be drilled inside of main body 356 so that latch mechanism 328 may be installed. In contrast, installation kit 324 may be applied to main body 356 by simply removing lengthwise section 360, which is less costly and time-consuming than drilling the special routing. Moreover, traditional door mechanisms require a set of blocks to be installed along free lateral free 354 of main body 356 during installation, so that latch mechanism 328 is concealed from view. Removable cap 326 will be less time-consuming to install than a set of blocks, and can also be removed with ease for access to latch mechanism 328.

Additionally, while FIG. 9 illustrates two U-shaped channel members 330, two hollow rod mechanisms 332, and two sliding portions 334, it should be noted that a single U-shaped channel member 330, hollow rod mechanism 332, and sliding portion 334 may be included in installation kit 324. A single U-shaped channel member 330, hollow rod mechanism 332, and sliding portion 334 may be used for either top edge 362 or, alternatively, the bottom edge of main body 356 as well.

The present invention has been particularly shown and described with reference to the foregoing embodiments, which are merely illustrative of the best modes for carrying out the invention. It should be understood by those skilled in the art that various alternatives to the embodiments of the invention described herein may be employed in practicing the invention without departing from the spirit and scope of the invention as defined in the following claims. It is intended that the following claims define the scope of the invention and that the method and apparatus within the scope of these claims and their equivalents be covered thereby. This description of the invention should be understood to include all novel and non-obvious combinations of elements described herein, and claims may be presented in this or a later application to any novel and non-obvious combination of these elements. Moreover, the foregoing embodiments are illustrative, and no single feature or element is essential to all possible combinations that may be claimed in this or a later application.

What is claimed is:

1. An exit door comprising:
an exit door main body having at least one outer edge and opposing faces;
an extended stile portion having an inner edge, said inner edge being affixed adjacent to and extending along at least a portion of said outer edge of said exit door main body;
at least one removable cap coupled to said extended stile portions an outer surface of said cap adjacent one of said opposing faces of said exit door main body; and
wherein said removable cap is thermally insulated from one of said opposing faces of said exit door main body.

2. The exit door of claim 1, wherein at least a first portion of said outer surface of said cap is generally flush with one of said opposing faces.

3. The exit door of claim 1, wherein a second portion of said outer surface of said cap is generally perpendicular to said first portion.

4. The exit door of claim 1, wherein at least a portion of said removable cap is interposed between one of said opposing faces of said exit door main body and said extended stile portion.

5. The exit door of claim 1, wherein said removable cap includes a thermally resistant material having a higher thermal resistance and a lower thermal conductivity than a material used with said extended stile portion.

6. The exit door of claim 1, wherein said exit door includes at least one latch mechanism retained within said extended stile portion and generally concealed by said removable cap, said latch mechanism including a latch bolt being at least partially slideable within said extended stile portion.

7. The exit door of claim 7, wherein said latch bolt selectively slides between a first locked position and a second unlocked position, and said latch bolt selectively protrudes away from said extended stile portion when said latch bolt moves towards said first locked position.

8. The exit door of claim 8, wherein said at least one outer edge of said exit door main body includes a first edge and a second edge generally perpendicular to said first edge, said inner edge of said extended stile portion being affixed adjacent to and extending along at least a portion of said first edge of said exit door main body, said latch bolt selectively protruding away from said second edge of said exit door main body when said latch bolt moves towards said first locked position.

9. The exit door of claim 6, wherein said latch mechanism further includes a channel member, said channel member includes an inner surface, an outer surface and a pair of edges.

10. The exit door of claim 9, said removable cap having an inner surface and wherein said channel member is disposed so that said inner surface is oriented towards an inner surface of said removable cap so that said pair of edges generally oppose said inner surface of said removable cap.

11. The exit door of claim 7, wherein said latch mechanism further includes a panic bar actuating pad disposed adjacent one of said opposing faces of said exit door main body and a rod mechanism, said rod mechanism including a first end and a second end, said first end operationally connected to said actuating pad and said second end operationally connected to said latch bolt, a force selectively manually applied to said panic bar actuating pad, said panic bar actuating pad allowing said latch bolt to slidingly recede inside within said extended stile portion when said latch bolt moves towards said second unlocked position.

12. The exit door of claim 1, wherein an external cladding is disposed on one of said opposing faces of said exit door main body, and is received by a recess disposed within said at least one outer edge of said exit door main body.

13. The exit door of claim 1, wherein at least one of said removable cap and said extended stile portion further includes at least two outwardly projecting mounting tabs, and the other of said removable cap and said extended stile portion further includes at least two slots in selective registry with and receiving said outwardly projecting mounting tabs to retain said removable cap on said extended stile portion by a snap-fit engagement.

14. The exit door of claim 1, wherein said removable cap is coupled to said extended stile portion by one of a snap-fit engagement, a slotted slide-fit engagement, an epoxy, and an adhesive.

15. The exit door of claim 1, wherein said removable cap completely encases said extended stile portion adjacent a first of said opposing faces of said exit door main body and said extended stile portion is exposed adjacent a second of said opposing faces of said exit door main body.

16. The exit door of claim 18, wherein an outermost surface of said door spaced away from said at least one outer edge of said exit door main body comprises both said removable cap and said extended stile portion.

17. An exit door stile comprising:
an extended stile portion;
a removable cap coupled to said extended stile portion;
a latch mechanism retained within said extended stile portion and generally concealed by said removable cap, said latch mechanism including a latch bolt being at least partially slideable within said extended stile portion;
wherein said latch bolt selectively slides between a first locked position and a second unlocked position, and said latch bolt protrudes away from said extended stile portion when said latch bolt moves towards said first locked position; and
wherein said removable cap is thermally insulated from at least a portion of said extended stile portion.

18. The exit door stile of claim 20, wherein said removable cap is constructed of a thermally resistant material having a higher thermal resistance and a lower thermal conductivity than a material used to construct said extended stile portion.

19. The exit door of claim 17, wherein said removable cap and said extended stile portion include opposing faces and at least one outer edge, wherein said removable cap completely encases said extended stile portion at a first of said opposing faces and said extended stile portion is exposed at a second of said opposing faces.

20. The exit door of claim 19, wherein said outer edge of said removable cap and said extended stile portion comprises both an outer edge of said removable cap and an outer edge of said extended stile portion.

21. An exit door comprising:
an exit door main body having at least one outer edge and opposing faces;
an extended stile portion having an inner edge, said inner edge being affixed adjacent to and extending along at least a portion of said outer edge of said exit door main body;
at least one removable cap coupled to said extended stile portion, an outer surface of said cap adjacent one of said opposing faces of said exit door main body, said removable cap is thermally insulated from one of said opposing faces of said exit door main body;
wherein said removable cap includes a thermally resistant material having a higher thermal resistance and a lower thermal conductivity than a material used with said extended stile portion;
wherein said removable cap completely encases said extended stile portion adjacent a first of said opposing faces of said exit door main body and said extended stile portion is exposed adjacent a second of said opposing faces of said exit door main body.

22. The exit door of claim 21, wherein an outermost surface of said door spaced away from said at least one outer edge of said exit door main body comprises both said removable cap and said extended stile portion.

23. The exit door of claim 21, wherein said exit door includes at least one latch mechanism retained within said extended stile portion and generally concealed by said removable cap, said latch mechanism including a latch bolt being at least partially slideable within said extended stile portion, said latch bolt selectively slides between a first locked position and a second unlocked position, and said latch bolt selectively protrudes away from said extended stile portion when said latch bolt moves towards said first locked position.

24. The exit door of claim 23, wherein said latch mechanism further includes a panic bar actuating pad disposed adjacent one of said opposing faces of said exit door main body and a rod mechanism, said rod mechanism including a first end and a second end, said first end operationally connected to said actuating pad and said second end operationally connected to said latch bolt, a force selectively manually applied to said panic bar actuating pad, said panic bar actuating pad allowing said latch bolt to slidingly recede inside within said extended stile portion when said latch bolt moves towards said second unlocked position.
